(19) United States
(12) Patent Application Publication
(10) Pub. No.: US 2003/0031154 A1
(43) Pub. Date: Feb. 13, 2003

(54) Network connection apparatus and network connection control method

(76) Inventors: Takero Kobayashi, Ome-shi (JP); Yasuhiro Ishibashi, Ome-shi (JP)

Correspondence Address: Finnegan, Henderson, Farabow,, Garrett & Dunner, L.L.P., 1300 I Street, N.W., Washington, DC, 20005-3315, US

(21) Appl. No.: 10/213,104

(22) Filed: Aug. 7, 2002

(30) Foreign Application Priority Data
Aug. 8, 2001 (JP) 2001-240726

(51) Int. Cl. H04Q 7/24

(52) U.S. Cl. 370/338

(57) ABSTRACT

A device authentication unit authenticates a wireless LAN terminal in response to a request from a connection control unit, and requests the connection control unit to send a device authentication result to a wireless LAN terminal. The connection control unit executes a procedure for device authentication between a wireless LAN control unit and the device authentication unit, and monitors a packet transmitted between the wireless LAN control unit and a bridge control unit. The connection control unit determines whether or not a wireless LAN terminal is already authenticated, on the basis of the MAC (Media Access Control) address assigned to the terminal, thereby transferring only acceptable packets, and braking off the other packets.

### CROSS-REFERENCE TO RELATED APPLICATIONS

This application is based upon and claims the benefit of priority from the prior Japanese Patent Application No. 2001-240726, filed Aug. 8, 2001, the entire contents of which are incorporated herein by reference.

### BACKGROUND OF THE INVENTION

1. Field of the Invention

The present invention relates to a network connection apparatus for connecting networks, and a network connection control method.

2. Description of the Related Art

Recently, various network connection methods for optimizing communications between networks have been proposed. For example, Microsoft Corporation and Cisco Corporation in the US have proposed a network connection method on a port-basis, called IEEE802.1x.

For communication management between networks, it is necessary, in light of security, to authenticate network nodes (such as terminals) on networks, which are connected to communication ports incorporated in a network connection apparatus. To this end, IEEE802.1x uses RADIUS (Remote Authentication Dial-In User Service) as a device authentication method for network nodes on networks. RADIUS is an authentication system developed by Livingston Enterprises Corporation in the Us.

When, for example, IEEE802.1x is used in a wireless LAN access point the network connection apparatus, the access point authenticates network nodes (such as terminals) on a wireless LAN, that are connected to the wireless LAN communication port of the apparatus. In this case, the access point serves as an authenticator, and cooperates with a RADIUS server as an authentication server connected thereto via, for example, a wired LAN, in order to execute authentication and communication management of wireless LAN communication terminals. The authenticated network node on the wireless LAN can then execute packet communication with network nodes on a network such as a wired LAN.

Japanese Patent Application KOKAI Publication No. 2001-111544 discloses an authentication method used between a wireless communication terminal, access point and RADIUS server.

However, the system using a RADIUS server is disadvantageous in that an unauthenticated network node on a wireless LAN cannot execute communication via any network communication port of the access point.

To overcome this problem, RADIUS may be incorporated in the access point to individually control the network communication ports, to which network nodes on the wireless LAN are accessible, on the basis of the device authentication results of RADIUS. However, RADIUS is expensive and complicated to operate, which imposes a burden on the users of the access point. Thus, this method is not desirable.

Further, it is demanded to enable a single apparatus to manage, with high security, communications on an external network such as the Internet, as well as communications on wireless and wired LANs.

### BRIEF SUMMARY OF THE INVENTION

Accordingly, it is an object of the present invention to provide a network connection apparatus of a high cost performance and a simple structure, which is equipped with a wireless communication port and a plurality of network communication ports, and is capable of implementing network connection with high security.

According to an aspect of the invention, there is provided a network connection apparatus, comprising a wireless communication port; a plurality of network communication ports; an authenticator configured to authenticate a network node connected to the wireless communication port; and a connection controller configured to determine whether or not data communication between the wireless communication port and one of the plurality of network communication ports is to be allowed, on the basis of an authentication result of the authenticator.

According to another aspect of the invention, there is provided a network connection apparatus, comprising a wireless network controller connectable with a wireless communication terminal; a network communication controller connectable with a plurality of network nodes; a memory configured to store media access control (MAC) addresses assigned to the wireless communication terminal and to the plurality of network nodes; an authenticator configured to authenticate the wireless communication terminal on the basis of the MAC addresses stored in the memory; and a connection controller configured to determine whether or not transfer of a packet from one of the plurality of network nodes to the wireless communication terminal or from the wireless communication terminal to one of the plurality of network nodes is to be allowed, on the basis of an authentication result of the authenticator.

According to yet another aspect of the invention, there is provided a network connection control method for use in a network connection apparatus having a wireless network controller connectable with a wireless communication terminal and a network communication controller connectable with a plurality of network nodes, the method comprising authenticating the wireless communication terminal on the basis of a media access control (MAC) address assigned to the wireless communication terminal; storing at least a result of the authentication; and determining whether or not transfer of a packet from one of the plurality of network nodes to the wireless communication terminal or from the wireless communication terminal to one of the plurality of network nodes is to be allowed, on the basis of at least the result of the authentication stored.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram illustrating a hardware structure for implementing a network connection apparatus according to an embodiment of the invention;

FIG. 2 is a block diagram illustrating a software structure for implementing the network connection apparatus according to the embodiment of the invention; and

FIG. 3 is a flowchart useful in explaining a procedure for connection control executed in the embodiment.

### DETAILED DESCRIPTION OF THE INVENTION

An embodiment of the invention will be described with reference to the accompanying drawings.

FIG. 1 is a block diagram illustrating a hardware structure for implementing a network connection apparatus according to the embodiment of the invention.

As shown, a CPU (Central Processing Unit) 1 controls the entire system. For example, it processes various drivers or protocols in accordance with a control program stored in a memory 3.

A bus bridge (north bridge) 2 manages data communications between the CPU 1, memory 3 and various controllers 4 to 7.

The memory 3 stores a control program in which an operation procedure is written, and temporarily stores packet data exchanged between the controllers 5 to 7.

An HDD (Hard Disk Drive) controller 4 is provided for controlling an HDD 41, and executes reading of the control program from the HDD 41, and storage and reading of device authentication data.

An ADSL (Asymmetric Digital Subscriber Line) controller 5 is provided for controlling, via an ADSL communication port 51, connection of the apparatus to ADSL that is connected to the Internet. A controller and communication port corresponding to ATM (Asynchronous Transfer Mode), ISDN (Integrated Services Digital Network) or FTTH (Fiber To The House), in place of ADSL, may be employed.

An NIC (Network Interface Card) controller 6 is provided for controlling NIC connected to a wired LAN (such as Ethernet) via a wired LAN communication port 61. The wired LAN communication port 61 can be connected to a wired LAN communication terminal as a network node on the wired LAN.

A wireless LAN controller 7 is provided for controlling connection of the apparatus to a wireless LAN via a wireless LAN communication port 71. The wireless LAN communication port 71 can be connected to a wireless LAN communication terminal as a network node on the wireless LAN.

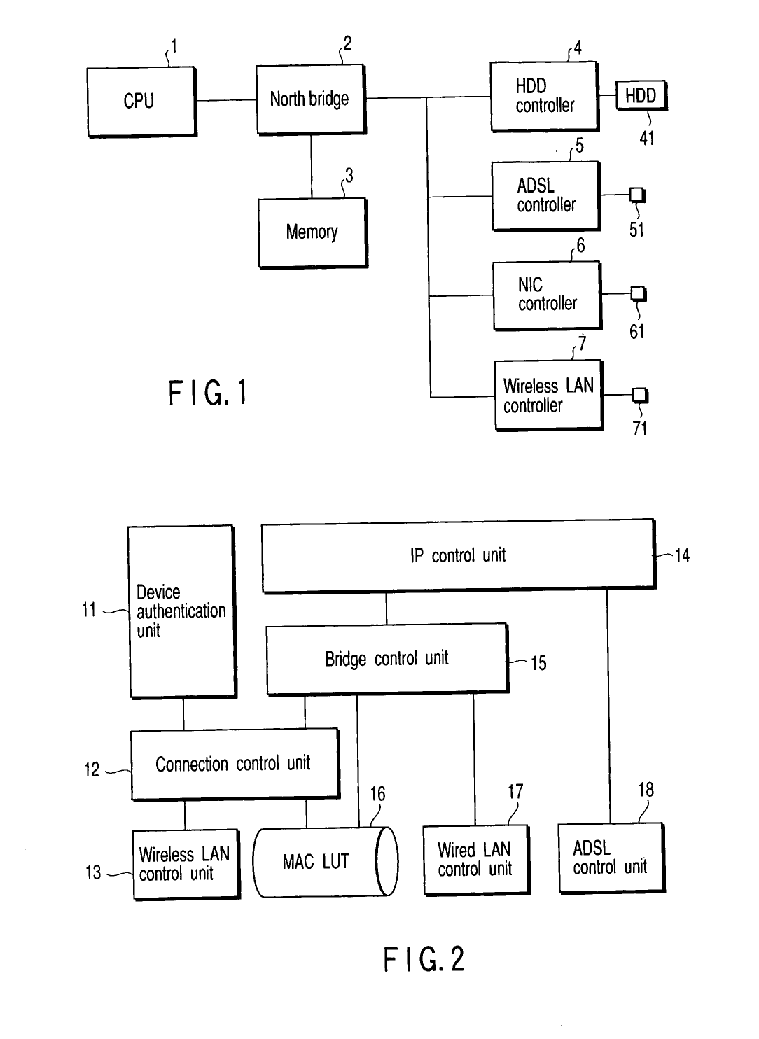

FIG. 2 shows a software structure for implementing the network connection apparatus according to the embodiment of the invention.

A device authentication unit 11 executes device authentication based on IEEE802.1x specifications. Specifically, the device authentication unit 11 authenticates a wireless LAN communication terminal in response to a request from a connection control unit 12, and requests the connection control unit 12 to transmit the authentication result to the wireless LAN communication terminal. Further, the device authentication unit 11 provides an authenticated wireless LAN communication terminal with information necessary for encryption executed on a to-be-transmitted packet, as well as the authentication result.

The connection control unit 12 executes connection control based on IEEE802.1x in accordance with the aforementioned control program. The connection control unit 12 executes a procedure for device authentication between the device authentication unit 11 and a wireless LAN control unit 13, and also monitors packets exchanged between a bridge control unit 15 and the wireless LAN control unit 13. Further, the control unit 12 determines whether or not each wireless LAN communication terminal is already authenticated, on the basis of the MAC (Media Access Control) address assigned to each wireless LAN communication terminal, thereby transferring acceptable packets alone and breaking off the other packets.

The wireless LAN control unit 13 corresponds to the wireless LAN controller 7 shown in FIG. 1. The wireless LAN control unit 13 transmits, to the connection control unit 12, a request for device authentication or for packet transfer, which has been issued from a wireless LAN communication terminal on the wireless LAN connected to the wireless LAN communication port 71. Further, the control unit 13 receives, from the connection control unit 12, an authentication result concerning a wireless LAN communication terminal, or a request for processing a packet.

An IP (Internet Protocol) control unit 14 executes an IP routine process between the bridge control unit 15 and an ADSL control unit 18.

The bridge control unit 15 executes a bridge process between the connection control unit 12 and a wired LAN control unit 17, thereby transferring acceptable packets to the IP control unit 14, and making an MAC LUT 16 reflect the states of network nodes (wireless/wired LAN communication terminals) connected to the wired and wireless LANs.

The MAC LUT (Look Up Table) 16 stores information (MAC addresses, authentication results, etc.) on the network nodes connected to the wired and wireless LANs. The contents of the MAC LUT 16 are updated by the bridge control unit 15 and referred to by the connection control unit 12.

The wired LAN control unit 17 corresponds to the NIC controller 6 shown in FIG. 1. The control unit 17 transmits, to the bridge control unit 15, a packet received from a wired LAN communication terminal on the wired LAN connected to the wired LAN communication port 61. Further, the control unit 17 transmits a packed received from the bridge control unit 15 to a wired LAN communication terminal on the wired LAN.

The ADSL control unit 18 corresponds to the ADSL controller 5 shown in FIG. 1. The control unit 18 transmits a packed received from ADSL, to the IP control unit 14, or vice versa.

IEEE802.11i, for example, may be used as a device authentication and encryption system for a wireless LAN communication terminal. Further, IEEE802.11, IEEE802.11a, IEEE802.11b or IEEE802.11g may be used as a wireless communication system. Instead of wireless LAN techniques, Bluetooth may be employed.

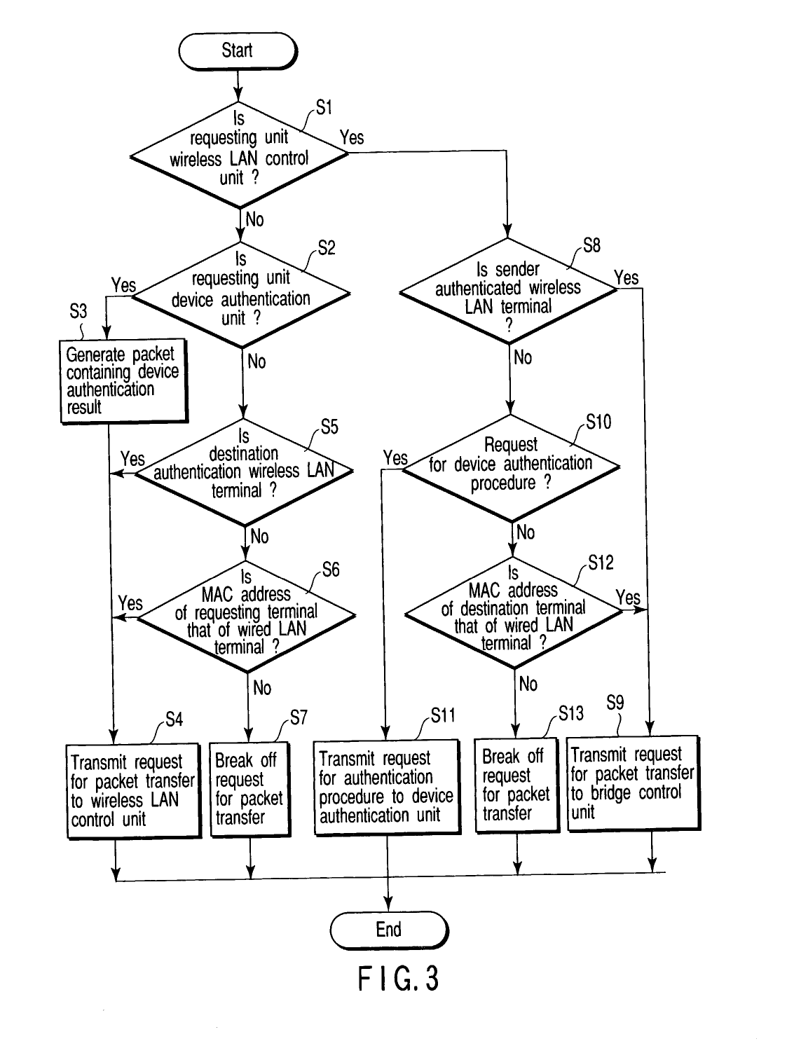

Referring now to FIG. 3, a procedure for connection control employed in the embodiment will be described.

Upon receiving a request for processing from one of the device authentication unit 11, wireless LAN control unit 13 and bridge control unit 15, the connection control unit 12 determines whether or not the requesting unit is the wireless LAN control unit 13 (step S1).

If it determines at the step S1 that the requesting unit is not the wireless LAN control unit 13, the connection control unit 12 determines whether or not the requesting unit is the device authentication unit 11 (step S2).

If the control unit 12 determines at the step S2 that the requesting unit is the device authentication unit 11, the request is considered to be a request for transmitting a device authentication result issued from the device authentication unit 11. In this case, the connection control unit 12 generates a response packet for a wireless LAN terminal in response to a request to transmit the device authentication result to the terminal, issued from the device authentication unit 11 (step S3), and transmits a request for processing the packet to the wireless LAN control unit 13 (step S4).

On the other hand, if it is determined at the step S2 that the requesting unit is not the device authentication unit 11, the requesting unit is determined to be the bridge control unit 15. The request from the bridge control unit 15 is a request for packet transfer to a wireless LAN terminal. Therefore, the connection control unit 12 refers to the MAC LUT 16, and determines whether or not the MAC address of a destination, which is contained in the request for packet transfer, indicates an already authenticated wireless LAN terminal (step S5).

If it determines at the step S5 that the MAC address of the destination indicates an already authenticated wireless LAN terminal, the connection control unit 12 transmits, to the wireless LAN control unit 13, the request for packet transfer from the bridge control unit 15 (step S4). If, on the other hand, it determines at the step S5 that the MAC address of the destination does not indicate an already authenticated wireless LAN terminal (i.e., if the MAC address indicates an unauthenticated wireless LAN terminal), the connection control unit 12 determines whether or not the MAC address of the sender is a MAC address assigned to a wired LAN communication terminal (step S6). In other words, it is determined at this step whether or not the communication is to be executed on the LAN including the wired and wireless LANs.

If it determines at the step S6 that the MAC address of the sender is the MAC address assigned to a wired LAN communication terminal (i.e., if the communication is to be executed on the LAN including the wired and wireless LANs), the connection control unit 12 transmits, to the wireless LAN control unit 13, the request for packet transfer from the bridge control unit 15 (step S4). On the other hand, if it determines at the step S6 that the MAC address of the sender is not the MAC address assigned to a wired LAN communication terminal (i.e., if the communication is not executed on the LAN including the wired and wireless LANs), the connection control unit 12 breaks off the request for packet transfer from the bridge control unit 15 (step S7).

Further, if the requesting unit is determined to be the wireless LAN control unit 13 at the step S1, the request is a request for packet transfer from a wireless LAN terminal. Accordingly, the connection control unit 12 refers to the MAC LUT 16, and determines whether or not the MAC address of a sender, which is contained in the request for packet transfer, indicates an already authenticated wireless LAN terminal (step S8).

If it determines at the step S8 that the MAC address of the sender indicates an already authenticated wireless LAN terminal, the connection control unit 12 transmits, to the bridge control unit 15, the request for packet transfer from the wireless LAN control unit 13 (step S9). If, on the other hand, it determines at the step S8 that the MAC address of the sender does not indicate an already authenticated wireless LAN terminal, the connection control unit 12 determines whether or not the request for packet transfer from the wireless LAN control unit 13 is a request for a device authentication procedure (step S10).

If it is determined at the step S10 that the request from the wireless LAN control unit 13 is a request for a device authentication procedure, the connection control unit 12 requests the authentication unit 11 to authenticate the wireless communication terminal (step S11). On the other hand, if the request from the wireless LAN control unit 13 is not a request for a device authentication procedure (i.e., if the request is other than that for the device authentication procedure), the connection control unit 12 determines whether or not the MAC address assigned to the destination is a MAC address assigned to a wired LAN communication terminal (step S12). In other words, it is determined at this step whether or not the communication is to be executed on the LAN including the wired and wireless LANs.

If it determines at the step S12 that the MAC address of the destination is the MAC address assigned to a wired LAN communication terminal (i.e., if the communication is to be executed on the LAN including the wired and wireless LANs), the connection control unit 12 transmits, to the wired LAN control unit 17, the request for packet transfer from the wireless LAN control unit 13 (step S9). On the other hand, if it determines at the step S12 that the MAC address of the destination terminal is not the MAC address assigned to a wired LAN communication terminal (i.e., if the communication is not executed on the LAN including the wired and wireless LANs), the connection control unit 12 breaks off the request for packet transfer from the wireless LAN control unit 13 (step S13).

As described above, according to the embodiment, a network connection apparatus can be efficiently implemented, which has a wireless communication access point function (bridge function), and a device authentication function for authenticating wireless LAN communication terminals, and serves as a router (i.e., it has a function for relaying data communications between a wireless communication port and a plurality of networks). In particular, since the apparatus incorporates the device authentication function for authenticating a wireless LAN communication terminal connected to the wireless communication port, and determines, on the basis of the authentication result, whether or not, for example, each packet can be transmitted from the wireless LAN communication terminal to, for example, the Internet, network connection with high security can be implemented by a single network connection apparatus of a high cost performance and simple structure.

Further, each packet can be encrypted to thereby implement communication management with higher security, since the device authentication unit 11 provides an authenticated wireless LAN communication terminal with information necessary for encryption of a packet.

Moreover, even a wireless LAN communication terminal that is not authenticated by the device authentication unit 11 is controlled to be able to execute communication if it uses a predetermined network communication port (e.g., a wired LAN communication port). Thus, further efficient and prompt communication can be implemented.

As described above in detail, the invention can provide a network connection apparatus of high security and simple structure at low cost, which includes a single wireless communication port and a plurality of other network communication ports.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A network connection apparatus, comprising:
a wireless communication port;
a plurality of network communication ports;
an authenticator configured to authenticate a network node connected to the wireless communication port; and
a connection controller configured to determine whether or not data communication between the wireless communication port and one of the plurality of network communication ports is to be allowed, on the basis of an authentication result of the authenticator.

2. The apparatus according to claim 1, wherein the authenticator provides the network node with information for encryption adapted to a packet that is to be transmitted from the network node when the network node has been successfully authenticated.

3. The apparatus according to claim 1, wherein the connection controller allows the network node connected to the wireless communication port to communicate with a specified one of the plurality of network communication ports even if the network node has not been authenticated by the authenticator.

4. The apparatus according to claim 1, wherein the wireless communication port is a wireless local area network (LAN) communication port, and the plurality of network communication ports include a wired LAN communication port and a network communication port other than LAN communication ports.

5. The apparatus according to claim 4, wherein the connection controller allows the network node connected to the wireless LAN communication port to communicate with the wired LAN communication port even if the network node has not been authenticated by the authenticator.

6. A network connection apparatus, comprising:
a wireless network controller connectable with a wireless communication terminal;
a network communication controller connectable with a plurality of network nodes;
a memory configured to store media access control (MAC) addresses assigned to the wireless communication terminal and to the plurality of network nodes;
an authenticator configured to authenticate the wireless communication terminal on the basis of the MAC addresses stored in the memory; and
a connection controller configured to determine whether or not transfer of a packet from one of the plurality of network nodes to the wireless communication terminal or from the wireless communication terminal to one of the plurality of network nodes is to be allowed, on the basis of an authentication result of the authenticator.

7. The apparatus according to claim 6, wherein the memory stores the authentication result, and the connection controller refers to the authentication result stored in the memory.

8. The apparatus according to claim 6, wherein the connection controller refers to an MAC address assigned to a destination to which the packet is to be transferred, or an MAC address assigned to a sender from which the packet is to be transferred, and also refers to the authentication result, so as to determine whether or not transfer of the packet is allowable.

9. The apparatus according to claim 6, wherein the wireless network controller is connected with a wireless local area network (LAN), and the network communication controller is connected with a wired LAN and a network other than LAN.

10. The apparatus according to claim 9, wherein the connection controller allows the wireless communication terminal connected to the wireless LAN to communicate with the wired LAN even if the wireless communication terminal has not been authenticated by the authenticator.

11. A network connection control method for use in a network connection apparatus having a wireless network controller connectable with a wireless communication terminal and a network communication controller connectable with a plurality of network nodes, the method comprising:
authenticating the wireless communication terminal on the basis of a media access control (MAC) address assigned to the wireless communication terminal;
storing at least a result of the authentication; and
determining whether or not transfer of a packet from one of the plurality of network nodes to the wireless communication terminal or from the wireless communication terminal to one of the plurality of network nodes is to be allowed, on the basis of at least the result of the authentication stored.

12. The method according to claim 11, wherein the determination is executed with reference to an MAC address assigned to a destination to which the packet is to be transferred, or an MAC address assigned to a sender from which the packet is to be transferred, and with reference to the result of the authentication.
